(19) United States
(12) Patent Application Publication
(10) Pub. No.: US 2020/0201870 A1
(43) Pub. Date: Jun. 25, 2020

(54) CONTENT CREATOR MESSAGING FRAMEWORK

(71) Applicant: Microsoft Technology Licensing, LLC, Redmond, WA (US)

(72) Inventors: Lu Chen, Sunnyvale, CA (US); Smriti Ramakrishnan, Belmont, CA (US); Shaunak Chatterjee, Sunnyvale, CA (US); Ajith Muralidharan, Sunnyvale, CA (US); Shipeng Yu, Sunnyvale, CA (US); Aklil Ibssa, San Francisco, CA (US); Liliya Mclean, San Jose, CA (US); Pratik Daga, Sunnyvale, CA (US); Jeffrey Zundel, Sunnyvale, CA (US); Jingshu Huang, Mountain View, CA (US); Naman Goel, San Jose, CA (US); Manoj Sivakumar, Mountain View, CA (US)

(21) Appl. No.: 16/226,974

(22) Filed: Dec. 20, 2018

(51) Int. Cl. G06F 16/2457; G06F 16/901

(52) U.S. Cl. CPC G06F 16/24578; G06F 16/9024

(57) ABSTRACT

Systems and techniques for content creator messaging framework are described herein. Information that indicates member activities corresponding to a content item corresponding to a content segment may be obtained for a date range. A set of distinct members may be determined that are associated with the information that indicates member activities. Edges may be identified in a connections network between each member of the set of distinct members and the content creator. An edge weight may be calculated for each edge using a number of interactions between content items created by the content creator and the member. A content creator ranking may be generated for the content creator using the edge weight for each edge. A content creator notification may be transmitted to the content creator based on determining that the content creator ranking is outside a threshold.

### TECHNICAL FIELD

Embodiments described herein generally relate to network notification provisioning in a connections network and, in some embodiments, more specifically to a content creator messaging framework for a connections network.

### BACKGROUND

A connections network may be a graph network including members as nodes and connections between members as edges. Members may create and distribute content via the connections network that may be interacted with (e.g., viewed, shared, commented on, liked, etc.) by other members of the connections network. Members may be encouraged to create content for distribution within the connections network. It may be desired to identify members that may create meaningful content for distribution on the connections network

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and system for a content creator messaging framework, according to an embodiment.

FIG. 2 illustrates a block diagram of an example of a system for top content creator selection for a content creator messaging framework, according to an embodiment.

FIG. 3 illustrates a block diagram of an example of a system for supply-demand determination for a content creator messaging framework, according to an embodiment.

FIG. 4 illustrates a flow diagram of an example of a method for a content creator messaging framework, according to an embodiment.

FIG. 5 is a block diagram illustrating an example of a machine upon which one or more embodiments may be implemented.

### DETAILED DESCRIPTION

Content creators may be a critical part of a connections network. Typical forms of content creation may include, for example, (1) maintaining and updating member profiles, (2) creating, editing and distributing different forms of content (text, images, audio, videos, etc.) through a connections network feed, (3) messaging, etc. Creating, editing and distributing different forms of content by members may increase the value of the connections network to other members, which may lead to increased interaction with the connections network.

To increase content sharing, it may be beneficial to provide members with feedback regarding the content they have created including whether the content has been interacted with by other members. Providing notifications to content creators regarding how they compare to other content creators may act as an incentive to content creators that may lead the content creators to create additional content.

Traditional content creator notification solutions may notify content creators when other members engage with their content (e.g., by liking, commenting, sharing, etc.). However, the traditional content creator notification solutions may not provide content creators with a notification that informs them of the relative value they are providing to the connections network by creating content and how their impact as a content creator is growing/shrinking over time. Furthermore, traditional content creator solutions may not provide notifications to those that have not created content but may be a potential source of meaningful content. Some members who are not content creators themselves, may not create content because of a lack of motivation or a feeling that creating content is too difficult a task for them. The non-contributing members may be provided an incentive to contribute if they are provided with a notification indicating the value of content created by other members.

The systems and techniques discussed herein provide notifications to content creators and non-content creators that may be the source of meaningful content. A notification may be transmitted to top (e.g., most popular, highest ranked, etc.) content creators which informs the top content creators within a content segment (e.g., topic, language, country, etc.) for a period of time (e.g., the past week, etc.). The notification may provide positive reinforcement to the content creators regarding the value they provide to the connections network ecosystem. The notifications may be provided in addition to more traditional, transaction-based, notifications regarding content created by the content creator. The top content creator notifications may include additional information that may help the content creator track their temporal trend in popularity within the connections network and the content segment.

Notification may also be provided to non-content creator members that may be selected from members sharing edge connections with the top content creator or are in a follower network of the top content creator. The notification to non-content creators helps non-content creators realize that members in their network are building their brand while providing value to the connections network ecosystem. The notifications may inspire the recipients to start creating and distributing content on the connections network.

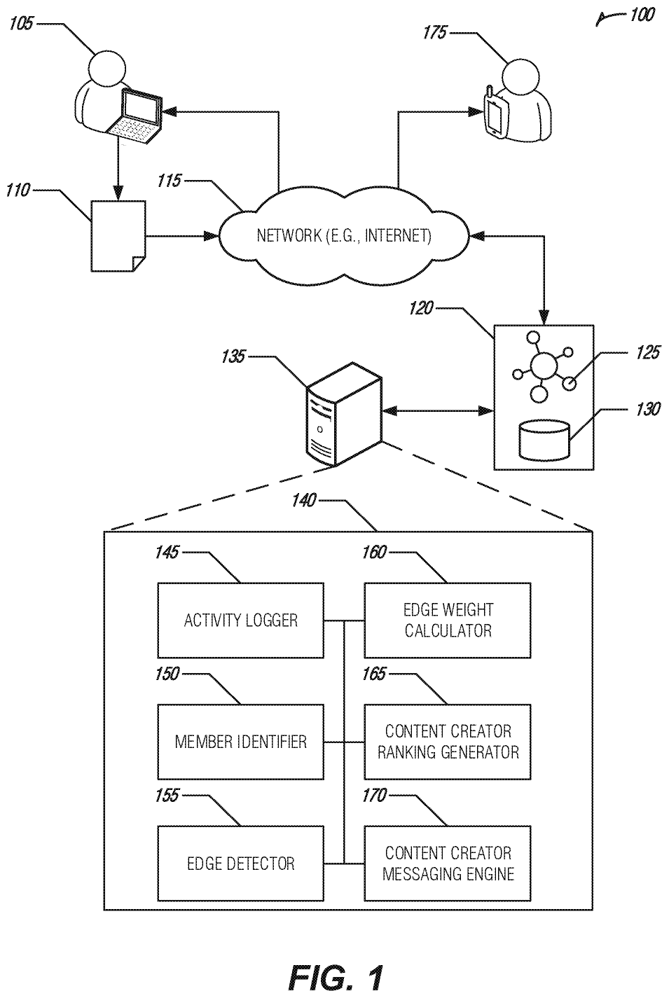

FIG. 1 is a block diagram of an example of an environment 100 and system 140 for a content creator messaging framework, according to an embodiment. The environment 100 may include a content creator 105 that has created content 110 (e.g., text, images, video, audio, etc.) for distribution on the connections network 120 via a network 115 (e.g., the internet, wired network, wireless network, cellular network, etc.). The environment 175 may include a member 175 of the connections network 120 that may interact with content 110 created by the content creator 105 or may share an edge (e.g., is a connection, a follower, etc.) in the connections network 120 with the content creator 105. The connections network 120 may include a graph network 125 including the content creator 105 and member 175 as nodes and the connection between the content creator 105, member 175, and other members as edges. The connections network 120 may include a variety of databases 130 including a variety of data including for example, member profile data, member activity data, content, etc.

The environment 100 may include a notification server 135 (e.g., a stand-alone server, cluster of servers, cloud computing platform, system on a chip, etc.) that may be communicatively coupled (e.g., via wired network, wireless network, cellular network, shared bus, etc.) to the data streams of the connections network 120. The notification server 135 may include the system 140. In an example, the system 140 may be a content creator notification engine. The system 140 may include a variety of components including an activity logger 145, a member identifier 150, an edge detector 155, an edge weight calculator 160, a content creator ranking generator 165, and a content creator messaging engine 170.

The activity logger 145 may extract member activity data from the databases 130. The activity logger 145 may obtain member activities that correspond to a content item that corresponds to a content segment (e.g., a topic, language, country, etc.) for a data range (e.g., a day, a week, a month, etc.). For example, the content creator 105 may have posted a video (e.g., the content 110, etc.) to the connections network 120 in the past week that has been tagged with a topic of “C programming.” Other members (e.g., the member 175, etc.) may perform activities related to the video such as, for example, viewing the video, liking the video, sharing the video with connections, commenting on the video, etc. The activities performed by the members may be stored in the databases 130. The activities in the databases 130 may then be analyzed to by the activity logger 145 to obtain those activities that correspond to the video on C programming created by the content creator 105.

The member identifier 150 may determine a set of distinct members associated with the member activities. Some members may have multiple interactions with (e.g., perform multiple activities associated with) a content item. For example, the member 175 may watch the C programming video and may share the video with other members that share an edge in the connections network 120 with the member 175. To accurately evaluate the content creator 105, it is useful to identify distinct members that have interacted with the content item 110. This may prevent anomalies such as high activity by a few members from skewing the analysis. Limiting evaluation to distinct members may also reduce the incidence of tampering by preventing a few members from performing multiple activities related to a content item in an attempt to influence the evaluation.

The edge detector 155 may identify edges in the connections network 120 between each member of the set of distinct members and the content creator 105. For example, the edge detector 155 may crawl the graph network 125 of the connections network 120 to identify edges between the content creator and the member 175. The edges may represent direct connections and indirect connections between the content creator 105 and the member 175. In an example, the member 175 may be a connection of the content creator 105. In another example, the member 175 may be a follower of content created by the content creator 105.

The edge weight calculator 160 may calculate an edge weight for each edge using a number of interactions between content items created by the content creator 105 and the member 175. In an example, the edge weight may be a matrix. The edge weight is generated based on potential interactions between the member 175 and the content creator 105. The higher the potential interaction between the member 175 and the content creator 105, the higher the edge may be weighted. Thus, edges that have a greater potential of being accessed are given preference while edges with little potential of being accessed are minimized.

The content creator ranking generator 165 may generate a content creator ranking for the content creator 105 using the edge weight for each edge. In an example, a page rank score may be generated for the content creator 105. The page rank score may indicate the importance and authority of content created by the content creator 105. In an example, PageRank may be used to rank content on a scale from 0 to 10. The page rank score may be determined in part based on a number of engagements between a member with a high page rank score and the content creator 105. The content creator 105 may be ranked with other content creators based on the page rank score and respective page rank scores of the other content creators and generation of the content creator rank may include use of the rank of the content creator in comparison to the other content creators.

In another example, a number of content items created by the content creator 105 may be calculated for a period of time. The number of content items created by the content creator 105 may be compared to respective numbers of content items created by other content creators to create a content item creation rank for the content creator 105 and generation of the content creator rank may include use of the content creation rank.

In another example, A number of responses received to content items created by the content creator 105 may be calculated for a period of time. The number of responses (e.g., likes, views, reshares, comments, etc.) received to content items created by the content creator 105 may be compared to respective numbers of responses received to content items created by other content creators to create a responses received rank for the content creator 105 and generation of the content creator rank may include use of the responses received rank.

In yet another example, a period of time may be calculated for content items created by the content creator 105 that correspond to the content segment. The period of time for content items created by the content creator 105 may be compared to respective periods of time for content items created by other content creators to create a contributor longevity rank for the content creator 105 and generation of the content creator rank may include use of the contributor longevity rank.

The content creator ranking generator may use an input graph G=(V, E, W) where V is a set of n vertices representing the members of the connections network 120 (e.g., as determined by the member identifier 150), E is a set of m directed edges representing relationships (e.g., connections, followers, etc.) between the member 175 and the content creator 105 (e.g., as determined by the edge detector 155), and W=[wᵢⱼ]_{n×n} is an edge weight matrix (e.g., calculated by the edge weight calculator 160) that indicates a likelihood of the member 175i engaging (e.g., liking, commenting, resharing, etc.) with the content item 110 created by the content creator 105j.

A graph may be built for the content segment. For example, the graph may be built for the C programming topic of the video created by the content creator 105. The member activities on content items that are associated (e.g., tagged, etc.) with the content segment in a content feed each day for the date range [d^{start}, d^{end}]. In an example, a record of the activity may have a format (memberId, topicId, outerActorId, numOfLikes, numOfComments, numOfShares, date) representing a number of interactions. The records for the content corresponding to the content segment is collected within the date range. The graph is built by (1) adding the distinct members into vertex set V, (2) adding each unique pair of (memberId, outerActorId) into the edge set E, (3) and calculating the weight of each edge as:

$${w}_{ij} = \frac{{s}_{ij}}{{\sum }_{k ∈ N ( i )} {s}_{ik}} , where {s}_{ij} = {\sum }_{t = 0}^{T} {e}^{- λ t} ( {l}_{ij}^{t} + {c}_{ij}^{t} + {r}_{ij}^{t} ) ,$$

sᵢⱼ denotes the total engagements that member i (e.g., the member 175) has taken with content from member j (e.g., the content creator 105), and N(i) denotes the set of members whom member i has engaged with.

To further explain the calculation of sᵢⱼ: lᵢⱼ^{t}, cᵢⱼ^{t}, and rᵢⱼ^{t} denote the normalized number of likes, comments and reshares that i has done with j's content on the topic at time t, t is the number of weeks (or days) between the date that the engagement occurred and the current date, the exponential decay factor e^{-λt} makes the value of engagement decrease as time passes, and λ is the exponential decay constant where λ>0. For example, if λ=0.5, the engagements of the current week will will not be decreased as e^{-λt}=e⁰=1, while the engagements that occurred the week before the current week will be decreased as e^{-λt}=e^{-0.5}<1.

In an example, a page rank score may be generated for each member in the graph G, and the members may be ranked by the pagerank score in descending order. A high page rank score may indicate high impact. Intuitively, a member with a lot of engagements from other members who have high page rank scores may also have high page rank scores.

The content creator messaging engine 170 may transmit a content creator notification to the content creator based on a determination that the content creator ranking is outside a threshold. For example, the ranked content creators may be placed in ranking buckets based on a percentile range of a group of ranked content creators. For example, buckets may be created for the top 1%, 5%, 10%, 15%, and 20%. The threshold may be set at bucket level and the content creators in that bucket and those above may be selected for receipt of the content creator notification. For example, if the threshold is set to the top 10%, content creators in the top 10%, top 5%, and top 1% buckets are sent the content creator notification. It will be understood that a variety of other thresholding techniques may be used in selecting content creators to receive the content creation notification. For example, the ten highest ranked content creators may be sent the content creator notification, etc. In an example, the content creator 105 may be selected for receipt of the content creator notification when a number of content items created during a period is greater than or equal to a first threshold, a number of responses received to content items is greater than or equal to a second threshold, and a time period that the content creator 105 has been providing content to the content segment is greater than or equal to a third threshold. Thus, the selection of candidates for receipt of content creation notifications may be fine tuned using multiple factors and thresholds to target notifications to content creators that are most likely to create meaningful content. Notifications may be transmitted in a variety of formats and via a variety of mediums. For example, the notification may be transmitted as a message in a notification area of a browser window, as a text message, as an email, as a post on a content feed, etc.

Notifications may also be transmitted by the content creator messaging engine 170 to members of the connections network 120 that are not current content creators to incentivize the members to create content. The potential recipients of the content creator message may be ranked based on content segment affinity, network affinities, notification affinity, etc. Content segment affinity selection may include determining the affinity of the member 175 based on activities the member 175 engages in with relation to the content segment and whether demand for the content segment out paces the current supply of content related to the content segment. A member interest graph may be established for the member 175 to determine the affinity of the member. Network affinities may evaluate whether the member is likely to interact with a top creator. This is a directional analysis that differentiates between interaction direction and public and private interaction. Previous interactions with the top creator may be evaluated in determining network affinity. Notification affinity may evaluate whether the member 175 is likely to interact with the notification (e.g., create content based on receipt of the notification, etc.). A group of members having an affinity for a content segment may then be ranked and may be selected to receive a notification based on their rank. In an example, the rank may be based on a combination of the content segment affinity, network affinity, and notification affinity.

In an example, a number of times a member (e.g., the member 175) of the set of distinct members has selected content items corresponding to the content segment may be identified by the activity logger 145. For example, the member 175 may have watched the C programming video, read a post regarding C programming, and liked several other C programming related content items. The number of times the member 175 has selected content items corresponding to the content segment may be compared to respective numbers of times other members of the set of distinct members have selected content items corresponding to the content segment by the content creator ranking generator 165 to create a content segment affinity rank for the member 175. For example, the member 175 may have a high number of selected C programming related content items compared to other members (e.g., in the top ten percentile, etc.). The content creator notification may be transmitted by the content creator messaging engine 170 to the member 175 based on the content segment affinity rank.

In an example, a supply of content for the content segment may be identified by the activity logger 145 based on a number of content items available in the connections network 120. For example, a quantity of content items related to C programming may be identified. A demand for the content segment may be determined by the activity logger 145 based on a number of interactions between members of the connections network and the content items. For example, how many members interact with the C programming content items and how frequently members interact with the C programming content items may be evaluated to determine the demand. A supply-demand ratio may be calculated for the content segment by the content creator ranking generator 165 and transmission of the content creator notification to the member 175 may be based on the supply-demand ratio. The supply-demand ratio describes to what extent the available content for the content segment matches the demand for content related to the content segment. For example, a low supply-demand ratio may indicate that there is insufficient content to meet demand while a high supply-demand ratio may indicate that there is more content for the content segment than the demand indicates is necessary. Thus, a content creation notification may be transmitted to a member with a high affinity for a content segment with insufficient content to incentivize the member to create content while no notification may be transmitted to a member with a high affinity for a content segment where supply out paces demand. By sending notifications to potential content creators where demand is higher than the available content, the connections network operator may be able to foster additional content to keep members engaged by providing meaningful content for consumption. If an insufficient supply of content is available to meet demand, members may leave the connections network or may seek other sources of meaningful content related to a particular content segment.

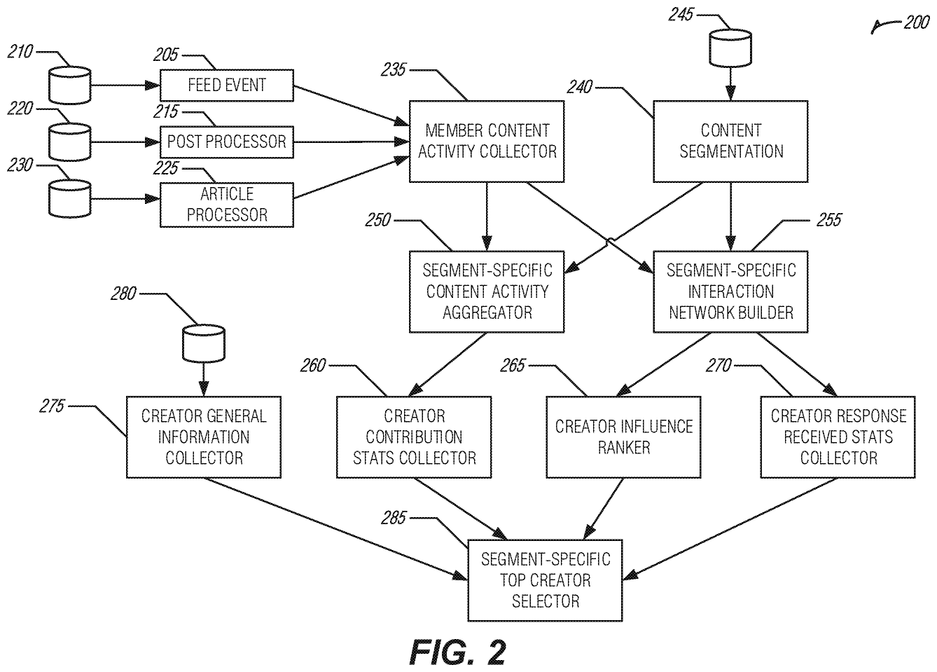

FIG. 2 illustrates a block diagram of an example of a system 200 for top content creator selection for a content creator messaging framework, according to an embodiment. The system 200 may provide features as described in FIG. 1.

Feed event data 205 may be collected from a feed data source 210 by a member content activity collector 235. Post data may be processed by a post processor 215 from a post data source 220 and collected by the member content activity collector 235. An article processor 225 may collect published content from a published content data source 230 for transmission to the member content activity collector. The member content activity collector 235 may combine the information from feed events, posts, and published articles to generate a dataset about member content activity. The dataset may be provided a segment-specific content activity aggregator 250 and a segment-specific interaction network builder 255. A content segmentation component 240 may collect content data for a content segment from a content data source 245. The content segmentation component 240 may generate segment tags for each content item. The content segmentation component 240 may provide the content segment data to the segment-specific content activity aggregator 250 and the segment-specific interaction network builder 255.

The segment-specific content activity aggregator 250 may aggregate members' activities per segment and may provide the aggregated content activity data to a creator contribution statistics collector 260. The creator contribution statistics collector 260 may collect information about contributions by the content creator (e.g., overall, per segment, etc.) such as, for example, number of published articles, posts, comments, etc.

The segment-specific interaction network builder 255 may generate an interaction network between members per segment. For example, a graph of a network may be generated for content items related to the content segment including edges between content creators and members interacting with the content. The network data may be provided to a creator influence ranker 265 and a creator response received statistics collector 270. The creator influence ranker 265 may rank content creators for a segment using a variety of different algorithms. For example, the content creators may be ranked using hyperlink-induced topic search (HITS), PageRank, etc. The creator response received statistics collector 270 may collect information about responses received from a network of the content creator (e.g., overall, per segment, etc.). For example, data may be collected such as number of likes/comments/reshares received for a content item, the number of unique members who liked/commented/reshared a content item, etc.

A creator general information collector 275 may collect general information about the content creator such as language, country, engagement level, connection count, follower count, whether the member is a known influencer, etc. from a user profile data source 280.

The data from the creator general information collector 275, creator contribution statistics collector 260, the creator influence ranker 265, and the creator response received statistics collector 270 may be provided to a segment-specific top creator selector 285. The segment-specific top creator selector 285 may combines all the received information about content creators and may select a list of top creators for the content segment. The selected content creators may be send a content creator notification.

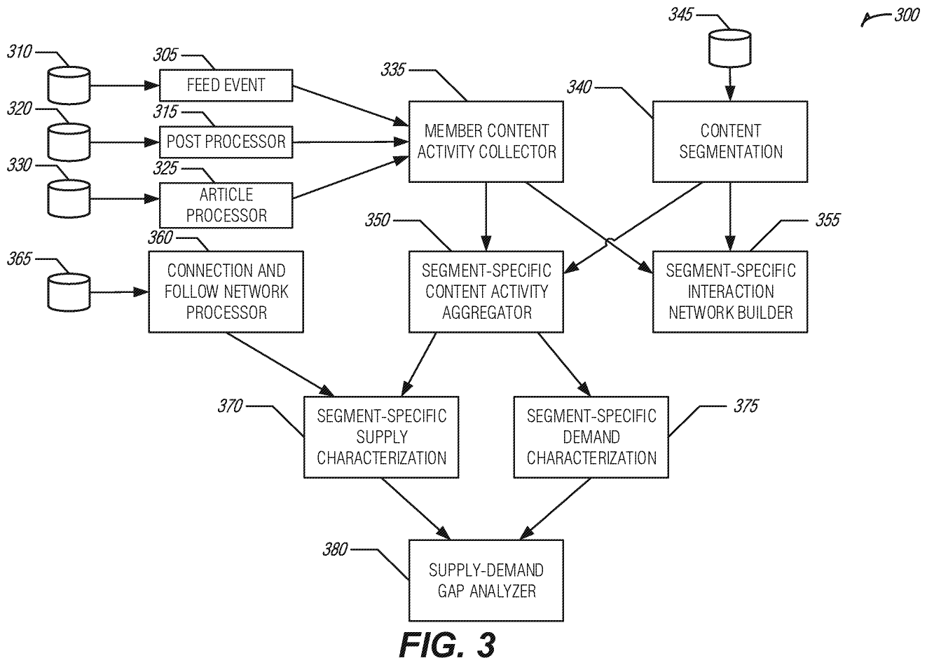

FIG. 3 illustrates a block diagram of an example of a system 300 for supply-demand determination for a content creator messaging framework, according to an embodiment. The system 300 may provide features as described in FIG. 1.

Feed event data 305 may be collected from a feed data source 310 by a member content activity collector 335. Post data may be processed by a post processor 315 from a post data source 320 and collected by the member content activity collector 335. An article processor 325 may collect published content from a published content data source 330 for transmission to the member content activity collector. The member content activity collector 335 may combine the information from feed events, posts, and published articles to generate a dataset about member content activity. The dataset may be provided a segment-specific content activity aggregator 350 and a segment-specific interaction network builder 355. A content segmentation component 340 may collect content data for a content segment from a content data source 345. The content segmentation component 340 may generate segment tags for each content item. The content segmentation component 340 may provide the content segment data to the segment-specific content activity aggregator 350 and the segment-specific interaction network builder 355.

The segment-specific content activity aggregator 350 may aggregate members' activities per segment and may provide the aggregated content activity data to a segment-specific supply characterization component 370 and a segment-specific demand characterization component 375. The segment-specific supply characterization component 370 may determine a supply of content related to the content segment. The segment-specific demand characterization component 375 may determine a demand for content related to the content segment.

The segment-specific interaction network builder 355 may generate an interaction network between members per segment. For example, a graph of a network may be generated for content items related to the content segment including edges between content creators and members interacting with the content.

The segment-specific supply characterization component 370 and the segment-specific demand characterization component 375 may provide the supply and demand data to a supply-demand gap analyzer 380. The supply-demand gap analyzer 380 may evaluate the supply and demand data to determine (e.g., by calculating a supply-demand ratio, etc.) whether the current supply of content related to the content segment is sufficient to meet demand. The supply-demand determination may be used in selecting non-content creating members for receipt of content creator notifications.

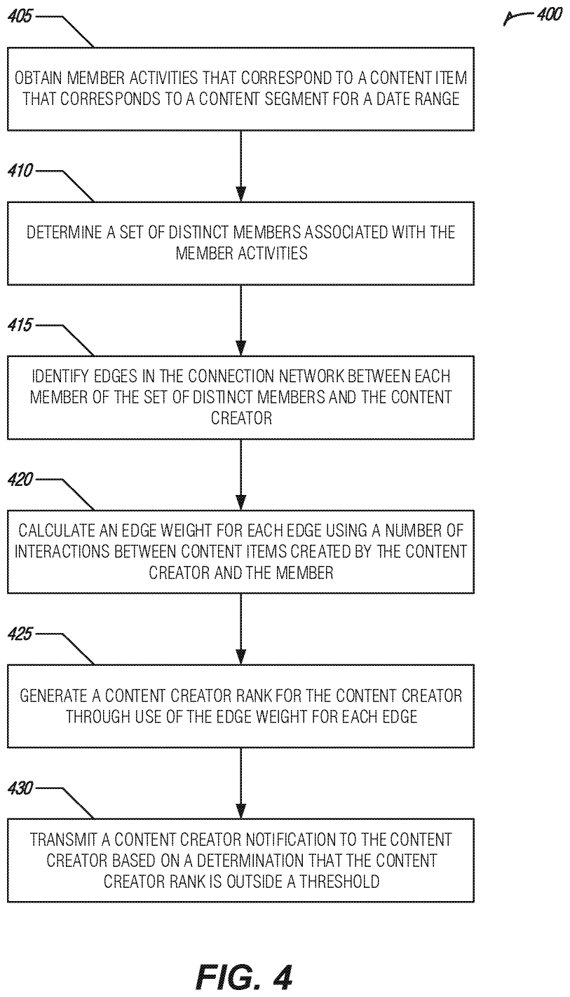

FIG. 4 illustrates a flow diagram of an example of a method 400 for a content creator messaging framework, according to an embodiment. The method 400 may provide features as described in FIGS. 1-3.

Member activities that correspond to a content item that corresponds to a content segment may be obtained (e.g., by the activity collector 145 as described in FIG. 1, etc.) for a date range (e.g., at operation 405). A set of distinct members may be determined (e.g., by the member identifier 150 as described in FIG. 1, etc.) that are associated with the member activities (e.g., at operation 410). Edges in the connections network may be identified (e.g., by the edge detector 155 as described in FIG. 1, etc.) between each member of the set of distinct members and the content creator (e.g., at operation 415). An edge weight may be calculated (e.g., by the edge weight calculator 160 as described in FIG. 1, etc.) for each edge using a number of interactions between content items created by the content creator and the member (e.g., at operation 420).

A content creator rank may be generated (e.g., by the content creator ranking generator 165 as described in FIG. 1, etc.) for the content creator using the edge weight for each edge (e.g., at operation 425). In an example, a page rank score may be generated for the content creator. The page rank score may be determined in part based on a number of engagements between a member with a high page rank score and the content creator. The content creator may be ranked with other content creators based on the page rank score and respective page rank scores of the other content creators and the generation of the content creator rank may use the rank of the content creator in comparison to the other content creators.

In another example, a number of content items created by the content creator may be calculated for a period of time. The number of content items created by the content creator may be compared to respective numbers of content items created by other content creators to create a content item creation rank for the content creator and generation of the content creator rank may use the content creation rank.

In another example, a number of responses received to content items created by the content creator may be calculated for a period of time. The number of responses received to content items created by the content creator may be compared to respective numbers of responses received to content items created by other content creators to create a responses received rank for the content creator and generation of the content creator rank may use the responses received rank.

In yet another example, a period of time may be calculated for content items created by the content creator that correspond to the content segment. The period of time for content items created by the content creator may be compared to respective periods of time for content items created by other content creators to create a contributor longevity rank for the content creator and generation of the content creator rank may use the contributor longevity rank.

A content creator notification may be transmitted (e.g., by the content creator messaging engine 170 as described in FIG. 1, etc.) to the content creator based on determining that the content creator ranking is outside a threshold (e.g., at operation 430).

In an example, a number of times a member of the set of distinct members has selected content items that correspond to the content segment may be determined. The number of times the member has selected content items corresponding to the content segment may be compared to respective numbers of times other members of the set of distinct members have selected content items corresponding to the content segment to create a content segment affinity rank for the member. The content creator notification may be transmitted to the member based on the content segment affinity rank. In an example, a supply of content for the content segment may be identified based on a number of content items available in the connections network. A demand for the content segment may be determined based on a number of interactions between members of the connections network and the content items. A supply-demand ratio may be calculated for the content segment and the content creator notification may be transmitted to the member based on the supply-demand ratio.

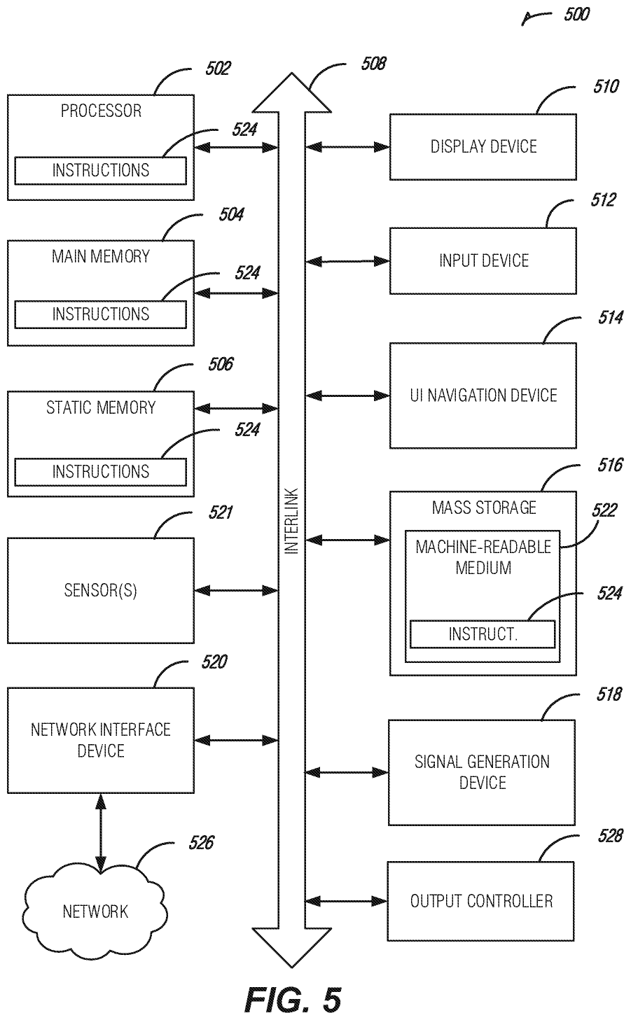

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine readable media). Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for a content creator notification framework in a connections network, the system comprising:
at least one processor; and
memory including instructions that, when executed by the at least one processor, cause the at least one processor to perform operations to:
obtain information that indicates member activities that correspond to a content item that corresponds to a content segment for a date range;
determine a set of distinct members associated with the information that indicates member activities;
identify edges in the connections network between each member of the set of distinct members and the content creator;
calculate an edge weight for each edge using a number of interactions between content items created by the content creator and the member;
generate a content creator rank for the content creator based on the edge weight for each edge;
transmit a content creator notification to the content creator based on a determination that the content creator rank is outside a threshold.

2. The system of claim 1, the memory further comprising instructions that, when executed by the at least one processor, cause the at least one processor to perform operations to:
generate a page rank score for the content creator, wherein the page rank score is determined in part based on a number of engagements between a member with a high page rank score and the content creator;
rank the content creator with other content creators based on the page rank score and respective page rank scores of the other content creators, wherein generation of the content creator rank includes use of the rank of the content creator in comparison to the other content creators.

3. The system of claim 1, the memory further comprising instructions that, when executed by the at least one processor, cause the at least one processor to perform operations to:
calculate a number of content items created by the content creator for a period of time; and
compare the number of content items created by the content creator to respective numbers of content items created by other content creators to create a content item creation rank for the content creator, wherein generation of the content creator rank includes use of the content creation rank.

4. The system of claim 1, the memory further comprising instructions that, when executed by the at least one processor, cause the at least one processor to perform operations to:
calculate a number of responses received to content items created by the content creator for a period of time; and
compare the number of responses received to content items created by the content creator to respective numbers of responses received to content items created by other content creators to create a responses received rank for the content creator, wherein generation of the content creator rank includes use of the responses received rank.

5. The system of claim 1, the memory further comprising instructions that, when executed by the at least one processor, cause the at least one processor to perform operations to:
calculate a period of time for content items created by the content creator that correspond to the content segment; and
compare the period of time for content items created by the content creator to respective periods of time for content items created by other content creators to create a contributor longevity rank for the content creator, wherein generation of the content creator rank includes use of the contributor longevity rank.

6. The system of claim 1, the memory further comprising instructions that, when executed by the at least one processor, cause the at least one processor to perform operations to:
identify a number of times a member of the set of distinct members has selected content items that correspond to the content segment;
compare the number of times the member has selected content items that correspond to the content segment to respective numbers of times other members of the set of distinct members have selected content items that correspond to the content segment to create a content segment affinity rank for the member; and
transmit the content creator notification to the member based on the content segment affinity rank.

7. The system of claim 6, the memory further comprising instructions that, when executed by the at least one processor, cause the at least one processor to perform operations to;
identify a supply of content for the content segment based on a number of content items available in the connections network;
determine a demand for the content segment based on a number of interactions between members of the connections network and the content items;
calculate a supply-demand ratio for the content segment, wherein transmission of the content creator notification to the member is based on the supply-demand ratio.

8. At least one non-transitory machine-readable medium including instructions for a content creator notification framework in a connections network that, when executed by at least one processor, cause the at least one processor to perform operations to:
obtain information that indicates member activities that correspond to a content item that corresponds to a content segment for a date range;
determine a set of distinct members associated with the information that indicates member activities;
identify edges in the connections network between each member of the set of distinct members and the content creator;
calculate an edge weight for each edge using a number of interactions between content items created by the content creator and the member;
generate a content creator rank for the content creator based on the edge weight for each edge;
transmit a content creator notification to the content creator based on a determination that the content creator rank is outside a threshold.

9. The at least one non-transitory machine-readable medium of claim 8, further comprising instructions that, when executed by the at least one processor, cause the at least one processor to perform operations to:
generate a page rank score for the content creator, wherein the page rank score is determined in part based on a number of engagements between a member with a high page rank score and the content creator;
rank the content creator with other content creators based on the page rank score and respective page rank scores of the other content creators, wherein generation of the content creator rank includes use of the rank of the content creator in comparison to the other content creators.

10. The at least one non-transitory machine-readable medium of claim 8, further comprising instructions that, when executed by the at least one processor, cause the at least one processor to perform operations to:
calculate a number of content items created by the content creator for a period of time; and
compare the number of content items created by the content creator to respective numbers of content items created by other content creators to create a content item creation rank for the content creator, wherein generation of the content creator rank includes use of the content creation rank.

11. The at least one non-transitory machine-readable medium of claim 8, further comprising instructions that, when executed by the at least one processor, cause the at least one processor to perform operations to:
calculate a number of responses received to content items created by the content creator for a period of time; and
compare the number of responses received to content items created by the content creator to respective numbers of responses received to content items created by other content creators to create a responses received rank for the content creator, wherein generation of the content creator rank includes use of the responses received rank.

12. The at least one non-transitory machine-readable medium of claim 8, further comprising instructions that, when executed by the at least one processor, cause the at least one processor to perform operations to:
calculate a period of time for content items created by the content creator that correspond to the content segment; and
compare the period of time for content items created by the content creator to respective periods of time for content items created by other content creators to create a contributor longevity rank for the content creator, wherein generation of the content creator rank includes use of the contributor longevity rank.

13. The at least one non-transitory machine-readable medium of claim 8, further comprising instructions that, when executed by the at least one processor, cause the at least one processor to perform operations to:
identify a number of times a member of the set of distinct members has selected content items that correspond to the content segment;
compare the number of times the member has selected content items that correspond to the content segment to respective numbers of times other members of the set of distinct members have selected content items that correspond to the content segment to create a content segment affinity rank for the member; and
transmit the content creator notification to the member based on the content segment affinity rank.

14. The at least one non-transitory machine-readable medium of claim 13, further comprising instructions that, when executed by the at least one processor, cause the at least one processor to perform operations to;
identify a supply of content for the content segment based on a number of content items available in the connections network;
determine a demand for the content segment based on a number of interactions between members of the connections network and the content items;
calculate a supply-demand ratio for the content segment, wherein transmission of the content creator notification to the member is based on the supply-demand ratio.

15. A method for a content creator notification framework in a connections network, the method comprising:
obtaining information that indicates member activities corresponding to a content item corresponding to a content segment for a date range;
determining a set of distinct members associated with the information that indicates member activities;
identifying edges in the connections network between each member of the set of distinct members and the content creator;
calculating an edge weight for each edge using a number of interactions between content items created by the content creator and the member;
generating a content creator ranking for the content creator using the edge weight for each edge;
transmitting a content creator notification to the content creator based on determining that the content creator ranking is outside a threshold.

16. The method of claim 15, further comprising:
generating a page rank score for the content creator, wherein the page rank score is determined in part based on a number of engagements between a member with a high page rank score and the content creator;
ranking the content creator with other content creators based on the page rank score and respective page rank scores of the other content creators, wherein generating the content creator ranking includes using the rank of the content creator in comparison to the other content creators.

17. The method of claim 15, further comprising:
calculating a number of content items created by the content creator for a period of time; and
comparing the number of content items created by the content creator to respective numbers of content items created by other content creators to create a content item creation rank for the content creator, wherein generating the content creator ranking includes using the content creation rank.

18. The method of claim 15, further comprising:
calculating a number of responses received to content items created by the content creator for a period of time; and
comparing the number of responses received to content items created by the content creator to respective numbers of responses received to content items created by other content creators to create a responses received rank for the content creator, wherein generating the content creator ranking includes using the responses received rank.

19. The method of claim 15, further comprising:
calculating a period of time for content items created by the content creator that correspond to the content segment; and
comparing the period of time for content items created by the content creator to respective periods of time for content items created by other content creators to create a contributor longevity rank for the content creator, wherein generating the content creator ranking includes using the contributor longevity rank.

20. The method of claim 15, further comprising:
identifying a number of times a member of the set of distinct members has selected content items corresponding to the content segment;
comparing the number of times the member has selected content items corresponding to the content segment to respective numbers of times other members of the set of distinct members have selected content items corresponding to the content segment to create a content segment affinity rank for the member; and
transmitting the content creator notification to the member based on the content segment affinity rank.
